(19) United States
(12) Patent Application Publication
(10) Pub. No.: US 2017/0282060 A1
(43) Pub. Date: Oct. 5, 2017

(54) INPUT DEVICE ADAPTED FOR AN ELECTRONIC DEVICE

(71) Applicant: ACER INCORPORATED, New Taipei City (TW)

(72) Inventors: Jian-Siang Wang, New Taipei City (TW); Hung-Chi Chen, New Taipei City (TW); Huei-Ting Chuang, New Taipei City (TW); Yi-Chang Yeh, New Taipei City (TW)

(21) Appl. No.: 15/336,770

(22) Filed: Oct. 27, 2016

(30) Foreign Application Priority Data
Mar. 31, 2016 (TW) 105110179

(51) Int. Cl. A63F 13/24; A63F 13/214; A63F 13/42; G06F 1/16

(52) U.S. Cl. CPC A63F 13/24; G06F 1/1616; G06F 1/1662; G06F 1/1692; G06F 1/1669; A63F 13/214; A63F 13/42

(57) ABSTRACT

An input device installed on a housing includes a casing, a first input module, a second input module and a fixing mechanism. The casing has a first face and a second face opposite to the first face. The first input module is disposed on the first face. The second input module is disposed on the second face. The fixing mechanism is disposed on at least one of the casing and the housing. When the casing is oriented with the first face facing the housing to be installed into the housing, the fixing mechanism fixes the casing, such that the second input module is exposed on the casing. When the casing is oriented with the second face facing the housing to be installed into the housing, the fixing mechanism fixes the casing, such that the first input module is exposed on the casing.

### BACKGROUND OF THE INVENTION

### 1. Field of the Invention

The present invention relates to an input device, and more particularly, to an input device adapted for an electronic device and having different input modes.

### 2. Description of the Prior Art

With development of gaming industry, a gaming notebook is provided for the gaming industry. Generally speaking, the gaming notebook is equipped with a mechanical keyboard for satisfying operating feeling when a user plays gaming. However, compared to a membrane keyboard of a conventional notebook computer, the mechanical keyboard occupies a larger mechanical space due to a large pressing stroke, which constrains areas for disposing the conventional keyboard with numeric key switches and touch control panel module. Accordingly, the gaming notebook can only be equipped with one of the conventional keyboard with numeric key switches and touch control panel module, and it discourages application of the gaming notebook in the market.

### SUMMARY OF THE INVENTION

The present invention provides an input device with different input modes for solving above drawbacks.

According to an embodiment of the present invention, an input device adapted to an electronic device is disclosed. The electronic device has a housing, and the housing has a major input area and a secondary input area. The input device is installed on the secondary input area and includes a casing, a first input module, a second input module and a fixing mechanism. The casing has a first face and a second face opposite to the first face. The first input module is disposed on the first face. The second input module is disposed on the second face. The fixing mechanism is disposed on at least one of the casing and the housing. The fixing mechanism fixes the casing when the casing is installed in the secondary input area with the first face being oriented toward the secondary input area, such that the first input module is contained in the housing and the second input module is exposed from the secondary input area. The fixing mechanism fixes the casing when the casing is installed in the secondary input area with the second face being oriented toward the secondary input area, such that the second input module is contained in the housing and the first input module is exposed from the secondary input area.

According to another embodiment of the present invention, the input device further includes a circuit board, a first connector, a second connector, a third connector and a fourth connector. The circuit board is disposed inside the casing. The first connector is disposed on the circuit board and coupled to the first input module. The second connector is disposed on the circuit board and coupled to the second input module. The third connector is disposed on the casing and detachably mates with a host module of the electronic device. The fourth connector is disposed on the circuit board and coupled to the third connector.

According to another embodiment of the present invention, the third connector is a pogo pin connector, and the pogo pin connector includes a sleeve, a pin and a resilient member. The sleeve is fixed on the casing. The pin is slidably disposed in the sleeve. The resilient member is disposed in the sleeve and abuts against the pin.

According to another embodiment of the present invention, the first input module is a touch control module, and the second input module is a keyboard module.

According to another embodiment of the present invention, the fixing module includes a first magnetic module, a second magnetic module and a third magnetic module. The first magnetic module is disposed inside the casing. The second magnetic module is disposed inside the casing. The third magnetic module is disposed in the housing and selectively attracts the first magnetic module or the second magnetic module.

According to another embodiment of the present invention, the fixing module further includes a fourth magnetic module and a magnetically attracting member. The fourth magnetic module is movably disposed between a fixing structure and a stopping structure of the housing. The fourth magnetic module selectively attracts the first magnetic module or the second magnetic module. The fourth magnetic module moves toward the stopping structure and is stopped by the stopping structure when the fourth magnetic module selectively attracts the first magnetic module or the second magnetic module. The magnetically attracting member is fixed on the fixing structure of the housing and for attracting the fourth magnetic module.

According to another embodiment of the present invention, the input device further includes a magnet member and a first hall sensor. The magnet member is disposed inside the casing. The first hall sensor is disposed in the housing. The first hall sensor senses magnetic force generated by the magnet member when the casing is installed in the secondary input area with the first face being oriented toward the secondary input area, so as to activate the second input module.

According to another embodiment of the present invention, the input device further includes a second hall sensor disposed in the housing, the second hall sensor senses the magnetic force generated by the magnet member when the casing is installed in the secondary input area with the second face being oriented toward the secondary input area, so as to activate the first input module.

According to another embodiment of the present invention, the input device further includes a circuit board and a wireless transmitting module. The circuit board is disposed inside the casing and electrically connected to the first input module, the second input module, the first hall sensor and the second hall sensor. The wireless transmitting module is coupled to the circuit board. The circuit board activates the wireless transmitting module to make communication between the wireless transmitting module and the electronic device when the first hall sensor senses the magnetic force generated by the magnet member or when the second hall sensor senses the magnetic force generated by the magnet member.

According to another embodiment of the present invention, an engaging slot is formed on the casing, and the fixing mechanism includes a push button. The push button includes a button body and an engaging portion. The button body is slidably disposed on the housing and exposed from the housing. The engaging portion protrudes from the button body and detachably engages with the engaging slot.

According to another embodiment of the present invention, the fixing mechanism includes an engaging member and an elastic member. The engaging member is installed in the housing in a slidable manner and detachably engaged with the casing. The elastic member is disposed in the housing and for driving the engaging member to engage with the casing.

According to another embodiment of the present invention, an engaging slot is formed on the casing, and the engaging member includes a main body and an embedding portion. The main body is movably disposed in the housing and abuts against an end of the elastic member. The embedding portion extends from the main body and stretches into the secondary input area. The embedding portion detachably embeds with the engaging slot.

According to another embodiment of the present invention, the fixing mechanism further includes at least one recovery member. The at least one recovery member is installed in the secondary input area and for driving the casing to recover.

In summary, when a user is desired to use the second input module (e.g., a keyboard module) of the input device, the casing of the input device is installed on the secondary input area with the first face being oriented toward the secondary input area of the housing of a host module. Accordingly, the first input module is contained in the in the housing, and the second input module is exposed from the secondary input area, so that the user is able to operate the second input module. When the user is desired to use the first input module (e.g., a touch control module) of the input device, the casing of the input device is installed on the secondary input area with the second face being oriented toward the secondary input area of the housing of the host module. Accordingly, the second input module is contained in the in the housing, and the first input module is exposed from the secondary input area, so that the user is able to operate the first input module. In such a manner, the present invention is able to provide different operating modes of the first input module and the second input module according to user's demands on the secondary input area of the housing of the host module of the electronic device (e.g., a gaming notebook).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to a first embodiment to the present invention.

FIG. 2 is a diagram of an input device in another view according to the first embodiment of the present invention.

FIG. 3 is an exploded diagram of the input device according to the first embodiment of the present invention.

FIG. 4 is an exploded diagram of the input device in another view according to the first embodiment of the present invention.

FIG. 5 is a sectional diagram of the input device shown in FIG. 3 and taken along a section line X-X.

FIG. 6 is a functional block diagram of the input device according to the first embodiment of the present invention.

FIG. 7 is an exploded diagram of an input device and a housing according to a second embodiment of the present invention.

FIG. 8 is a diagram of the input device in another view according to the second embodiment of the present invention.

FIG. 9 is an exploded diagram of the input device according to the second embodiment of the present invention.

FIG. 10 is an exploded diagram of the input device in another view according to the second embodiment of the present invention.

FIG. 11 is a sectional diagram illustrating that the input device is separate from the housing according to the second embodiment of the present invention.

FIG. 12 is a sectional diagram illustrating that the input device is combined with the housing according to the second embodiment of the present invention.

FIG. 13 is a functional block diagram of the input device according to the second embodiment of the present invention.

FIG. 14 is a diagram illustrating that the input device is installed in a secondary input area of the electronic device according to the second embodiment of the present invention.

FIG. 15 is a sectional diagram illustrating that an input device is installed with a housing according to a third embodiment of the present invention.

FIG. 16 is a sectional diagram illustrating that the input device is detached from the housing according to the third embodiment of the present invention.

### DETAILED DESCRIPTION

In the following detailed description of the embodiments, reference is made to the accompanying drawings which form a part hereof, and in which is shown by way of illustration specific embodiments in which the invention may be practiced. In this regard, directional terminology, such as “top,” “bottom,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “installed” and variations thereof herein are used broadly and encompass direct and indirect connections and installations. Accordingly, the drawings and descriptions will be regarded as illustrative in nature and not as restrictive.

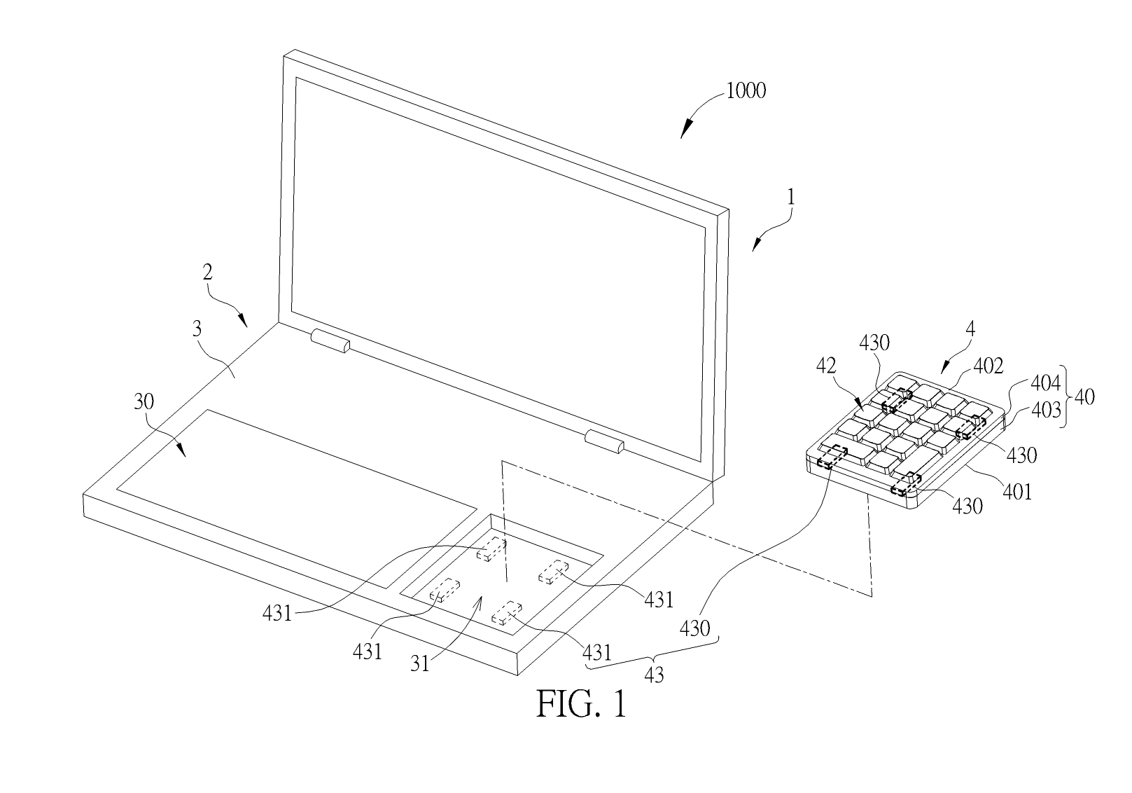

FIG. 1 is a schematic diagram of an electronic device 1000 according to a first embodiment to the present invention. As shown in FIG. 1, the electronic device 1000 includes a display module 1 and a host module 2. The display module 1 is pivoted to the host module 2, such that the display module 1 is able to be expanded or contained with respect to the host module 2. The host module 2 of the electronic device 1000 has a housing 3 and a mainboard (not shown in figures). The housing 3 covers and protects the mainboard, and the mainboard is used for controlling the display module 1 to display an operating interface, so that a user is able to operate the electronic device 1000 by the operating interface.

Furthermore, the housing 3 has a major input area 30 and a secondary input area 31. The major input area 30 is equipped with a keyboard. In this embodiment, the electronic device 1000 is a gaming notebook for electronic gaming. In practical application, the keyboard of the major input area 30 of the gaming notebook (i.e., electronic device 1000) is a keyboard with mechanical key switches for satisfying operating feeling of gaming, but the present invention is not limited thereto. Furthermore, the electronic device 1000 further includes an input device 4, and the input device 4 is installed on the secondary input area 31.

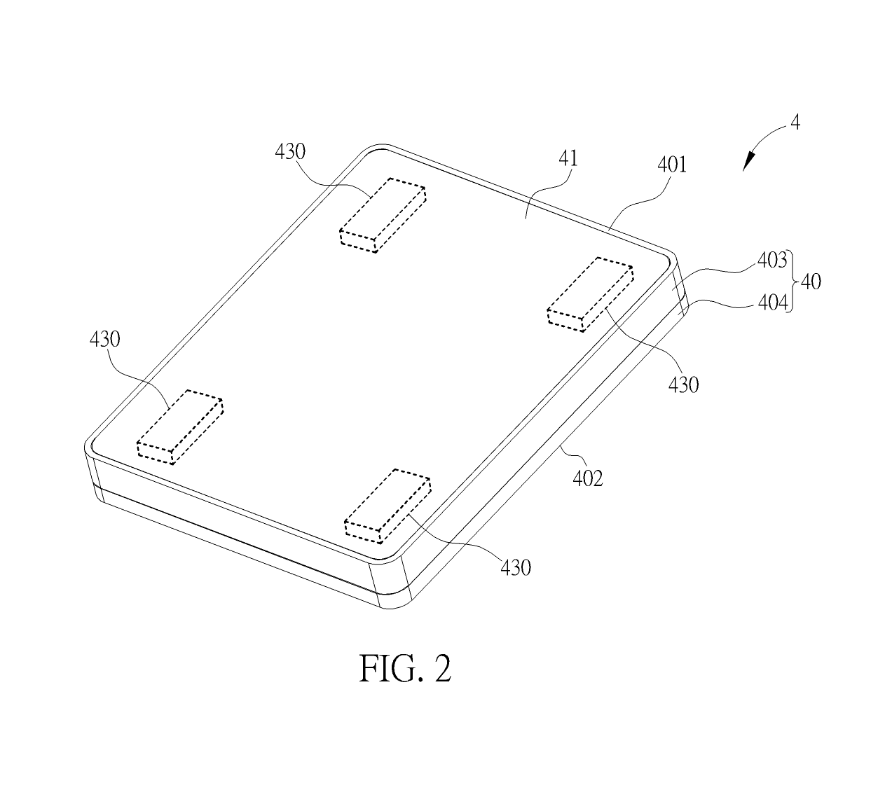

FIG. 2 is a diagram of the input device 4 in another view according to the first embodiment of the present invention. As shown in FIG. 1 and FIG. 2, the input device 4 includes a casing 40, a first input module 41 and a second input module 42. The casing 40 is detachably installed in the secondary input area 31 and has a first face 401 and a second face 402 opposite to the first face 401. The first input module 41 is disposed on the first face 401, and the second input module 42 is disposed on the second face 402. In this embodiment, the casing 40 can include an upper casing 403 and a lower casing 404. The first face 401 and the second face 402 are a top surface of the upper casing 403 and a top surface of the lower casing 404, and the upper casing 403 is assembled with the lower casing 404, so as to form the casing 40 for covering internal components of the input device 4, but the present invention is not limited thereto. In this embodiment, the first input module 41 is a touch control module, and the second input module 42 is a keyboard module, but the present invention is not limited thereto.

Furthermore, the input device 4 further includes a fixing mechanism 43. The fixing mechanism 43 is disposed on at least one of the casing 40 of the input device 4 and the housing 3 of the host module 2. In this embodiment, the fixing mechanism 43 can include four first magnet attracting members 430 and four second magnet attracting members 431. The four first magnet attracting members 430 are respectively disposed at four corners of the casing 40, and the four second magnet attracting members 431 are respectively disposed at four corners of the housing 3 and corresponding to the four first magnet attracting members 430. When the casing 40 of the input device 4 is installed on the secondary input area 31 with the first face 401 being oriented toward the secondary input area 31 of the housing 3 of the host module 2, the first magnet attracting members 430 attract the second magnet attracting members 431. Accordingly, the fixing mechanism 43 is able to fix the casing 40 with the housing 3. Meanwhile, the first input module 41 is contained in the housing 3 and the second input module 42 is exposed from the secondary input area 31. Similarly, when the casing 40 of the input device 4 is installed on the secondary input area 31 with the second face 402 being oriented toward the secondary input area 31 of the housing 3 of the host module 2, the first magnet attracting members 430 attract the second magnet attracting members 431. Accordingly, the fixing mechanism 43 is able to fix the casing 40 with the housing 3. Meanwhile, the second input module 42 is contained in the housing 3 and the first input module 41 is exposed from the secondary input area 31.

In such a manner, when the user is desired to use the second input module 42 (i.e., the keyboard module) of the input device 4, the casing 40 of the input device 4 is installed on the secondary input area 31 with the first face 401 being oriented toward the secondary input area 31 of the housing 3 of the host module 2. Meanwhile, the first input module 41 is contained in the housing 3 and the second input module 42 is exposed from the secondary input area 31, so that the user is able to operate the second input module 42 (i.e., the keyboard module). When the user is desired to use the first input module 41 (i.e., the touch control module) of the input device 4, the casing 40 of the input device 4 is installed on the secondary input area 31 with the second face 402 being oriented toward the secondary input area 31 of the housing 3 of the host module 2. Meanwhile, the second input module 42 is contained in the housing 3, and the first input module 41 is exposed from the secondary input area 31, so that the user is able to operate the first input module 41 (i.e., the touch control module). In such a manner, the present invention provides the user with different operating modes (i.e., the operating mode with respect to the first input module 41, i.e., the touch control module, or the operating mode with respect to the second input module 42, i.e. the keyboard module) on the secondary input area 31 of the housing 3 of the host module 2 of the electronic device 1000 (i.e., the gaming notebook computer for gaming industry) according to the user's demands.

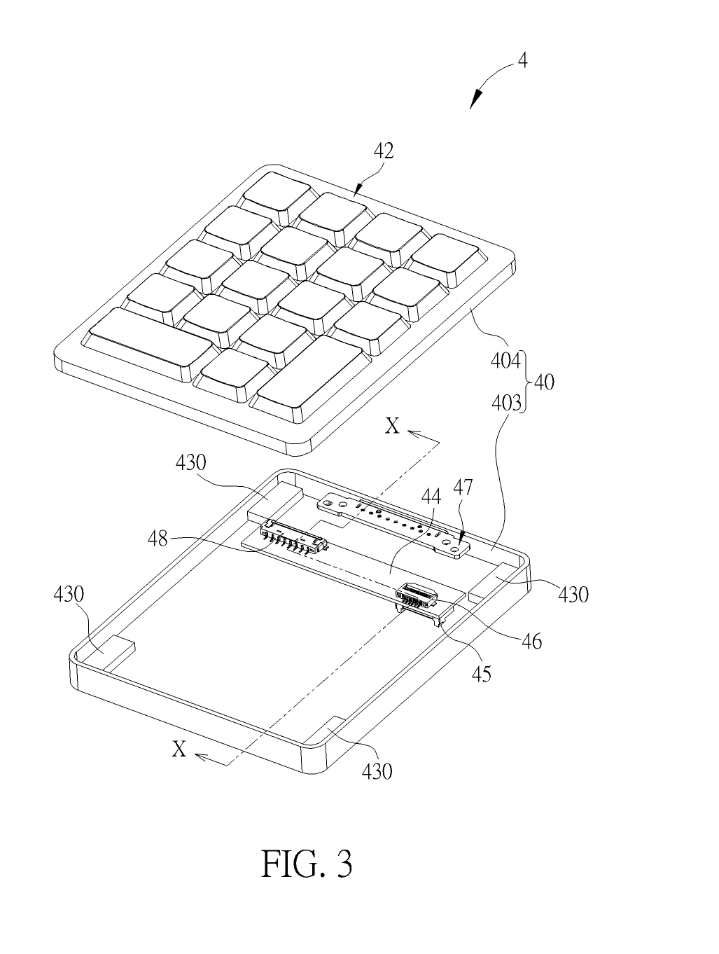

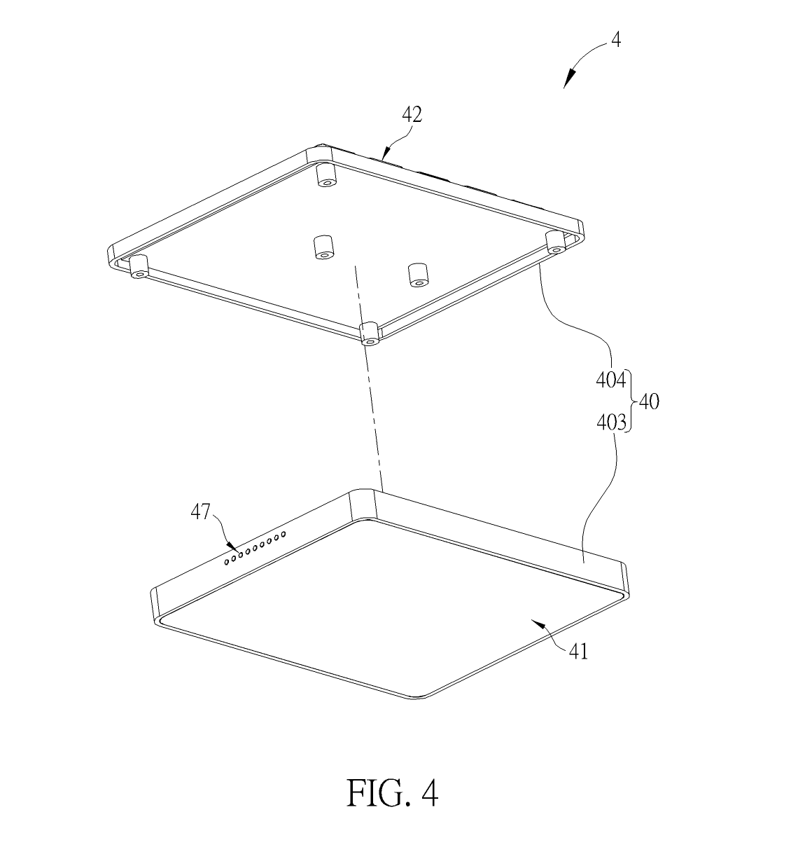

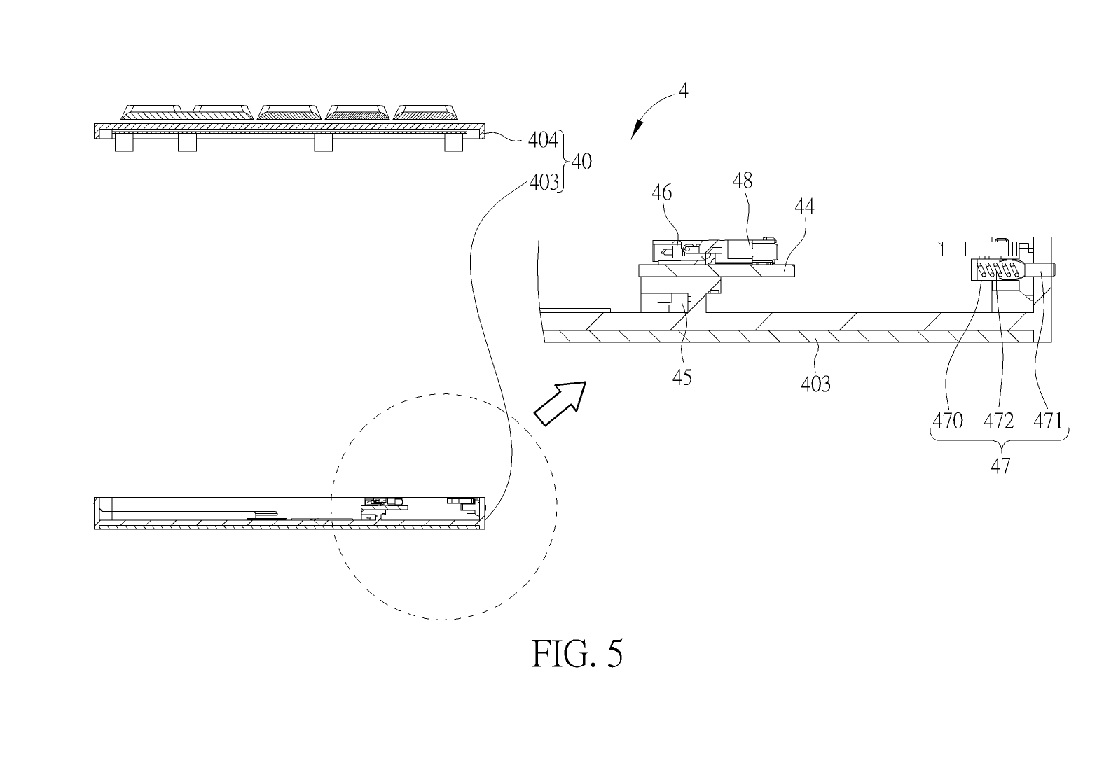

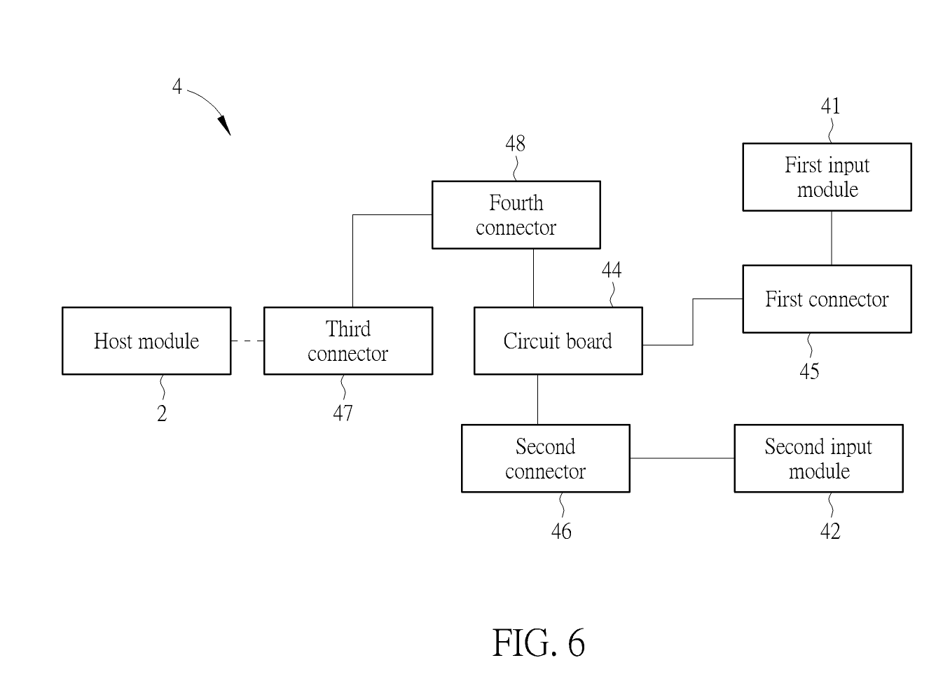

FIG. 3 is an exploded diagram of the input device 4 according to the first embodiment of the present invention. FIG. 4 is an exploded diagram of the input device 4 in another view according to the first embodiment of the present invention. FIG. 5 is a sectional diagram of the input device 4 shown in FIG. 3 and taken along a section line X-X. FIG. 6 is a functional block diagram of the input device 4 according to the first embodiment of the present invention. As shown in FIG. 3 to FIG. 6, the input device 4 further includes a circuit board 44, a first connector 45, a second connector 46, a third connector 47 and a fourth connector 48. The circuit board 44 is disposed inside the casing 40 of the input device 4. The first connector 45 is disposed on the circuit board 44 and coupled to the first input module 41, so that the circuit board 44 is electrically connected to the first input module 41. The second connector 46 is disposed on the circuit board 44 and coupled to the second input module 42, so that the circuit board 44 is electrically connected to the second input module 42. The third connector 47 is disposed on the casing 40 and detachably mates with the host module 2 of the electronic device 1000. The fourth connector 48 is disposed on the circuit board 44 and coupled to the third connector 47. Accordingly, the first input module 41 is able to communicate with the host module 2 via the first connector 45, the circuit board 44, the fourth connector 48 and the third connector 47, and the second input module 42 is able to communicate with the host module 2 via the second connector 46, the circuit board 44, the fourth connector 48 and the third connector 47.

In this embodiment, the third connector 47 is a pogo pin connector, as shown in FIG. 5. The pogo pin connector (i.e., the third connector 47) includes a sleeve 470, a pin 471 and a resilient member 472. The sleeve 470 is fixed on the casing 40 of the input device 4. The pin 471 is slidably disposed in the sleeve 470. The resilient member 472 is disposed in the sleeve 470 and abuts against the pin 471. During the input device 4 is installed on the secondary input area 31 of the housing 3 of the host module 2, the resilient member 472 of the third connector 47 drives the pin 471 to abut against a connector (not shown in figures) of the host module 2, such that the third connector 47 is electrically connected to the connector of the host module 2. Accordingly, the third connector 47 is electrically connected to the connector of the host module 2 in a resilient contact manner for facilitating the user to take the input device 4.

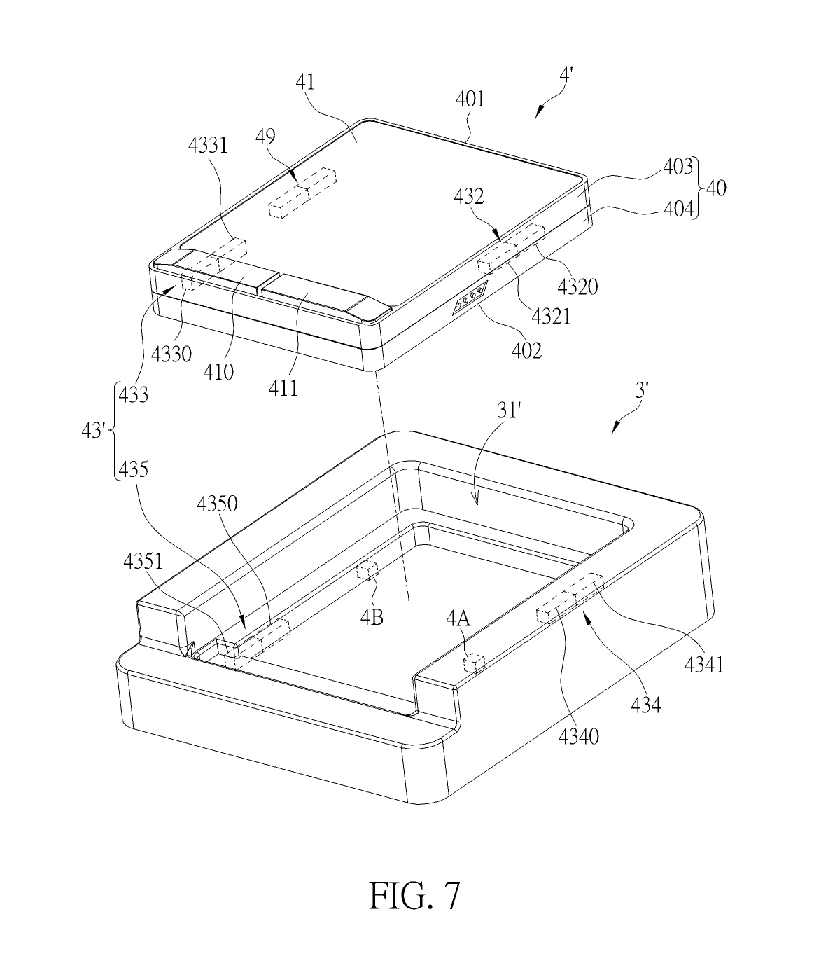

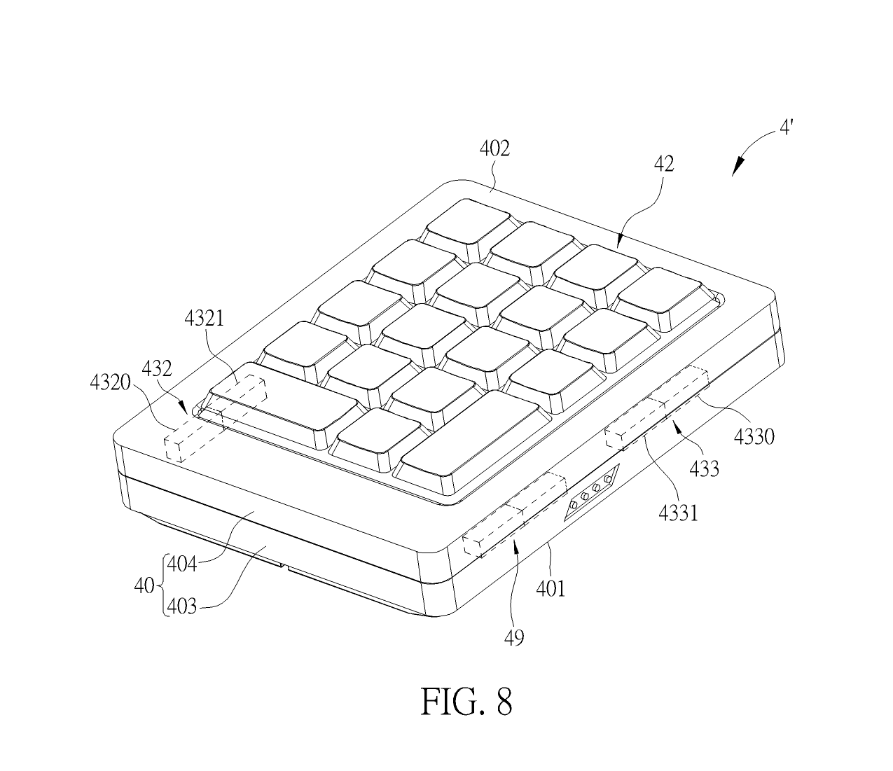

FIG. 7 is an exploded diagram of an input device 4′ and a housing 3′ according to a second embodiment of the present invention. FIG. 8 is a diagram of the input device 4′ in another view according to the second embodiment of the present invention. In this embodiment, the housing 3′ is a portion of a housing of an electronic device (e.g., a notebook computer), but the present invention is not limited thereto. As shown in FIG. 7 and FIG. 8, the main difference between the input device 4′ and the aforesaid input device 4 is that a fixing mechanism 43′ of the input device 4′ includes a first magnetic module 432, a second magnetic module 433, a third magnetic module 434 and a fourth magnetic module 435. The first magnetic module 432 and the second magnetic module 433 are disposed inside the casing 40. The third magnetic module 434 and the fourth magnetic module 435 are disposed in the housing 3′.

When the input device 4′ is installed on a secondary input area 31′ of the housing 3′ with the second face 402 of the casing 40 being oriented toward the secondary input area 31′, the third magnetic module 434 is for attracting the first magnetic module 432 and the fourth magnetic module 435 is for attracting the second magnetic module 433, so as to fix the input device 4′ in the secondary input area 31′ of the housing 3′ and allow the first input module 41 of the input device 4′ to be exposed from the secondary input area 31′. When the input device 4′ is installed on the secondary input area 31′ with the first face 401 of the casing 40 being oriented toward the secondary input area 31′ of the housing 3′, the third magnetic module 434 is for attracting the second magnetic module 433 and the fourth magnetic module 435 is for attracting the first magnetic module 432, so as to fix the input device 4′ in the secondary input area 31′ of the housing 3′ and allow the second input module 42 of the input device 4′ to be exposed from the secondary input area 31′. In other words, the third magnetic module 434 is able to selectively attracting the first magnet attracting members 430 or the second magnet attracting members 431 according to the practical demands, and the fourth magnetic module 435 is able to selectively attract the first magnet attracting members 430 or the second magnet attracting members 431 according to the practical demands as well, so as to fix the input device 4′ in the secondary input area 31′ and selectively allow the first input module 41 or the second input module 42 to be exposed from the secondary input area 31′.

Furthermore, the first magnetic module 432 has a first N-pole magnet 4320 and a first S-pole magnet 4321. The second magnetic module 433 has a second N-pole magnet 4330 and a second S-pole magnet 4331. The third magnetic module 434 has a third N-pole magnet 4340 and a third S-pole magnet 4341. The fourth magnetic module 435 has a fourth N-pole magnet 4350 and a fourth S-pole magnet 4351. The third N-pole magnet 4340 is corresponding to the first S-pole magnet 4321 or the second S-pole magnet 4331. The third S-pole magnet 4341 is corresponding to the first N-pole magnet 4320 or the second N-pole magnet 4330. The fourth N-pole magnet 4350 is corresponding to the first S-pole magnet 4321 or the second S-pole magnet 4331. The fourth S-pole magnet 4351 is corresponding to the first N-pole magnet 4320 or the second N-pole magnet 4330.

When the input device 4′ is installed in the secondary input area 31′ with the second face 402 of the casing 40 being oriented toward the secondary input area 31′ of the housing 3′, the first N-pole magnet 4320 and the first S-pole magnet 4321 respectively attract and are aligned with the third S-pole magnet 4341 and the third N-pole magnet 4340, and the second N-pole magnet 4330 and second S-pole magnet 4331 respectively attract and are aligned with the fourth S-pole magnet 4351 and the fourth N-pole magnet 4350. Similarly, when the input device 4′ is installed in the secondary input area 31′ with the first face 401 of the casing 40 being oriented toward the secondary input area 31′ of the housing 3′, the second N-pole magnet 4330 and second S-pole magnet 4331 respectively attract and are aligned with the third S-pole magnet 4341 and the third N-pole magnet 4340, and the first N-pole magnet 4320 and the first S-pole magnet 4321 respectively attract and are aligned with the fourth S-pole magnet 4351 and the fourth N-pole magnet 4350. In such a manner, the fixing mechanism 43′ is not only able to fix the input device 4′ with the housing 3′ but also position the input device 4′ onto the housing 3′ by utilizing principles of attracting of two opposite poles while repelling of two like poles.

It should be noticed that the first input module 41 of the input device 4′ is a touch control module with a first key switch 410 and a second key switch 411. When the first input module 41 displays a touch control interface, the first key switch 410 is for performing a first function, such as entering, opening a window and so on, and the second key switch 411 is for performing a second function, such as pop-up of the window and so on, but the present invention is not limited thereto.

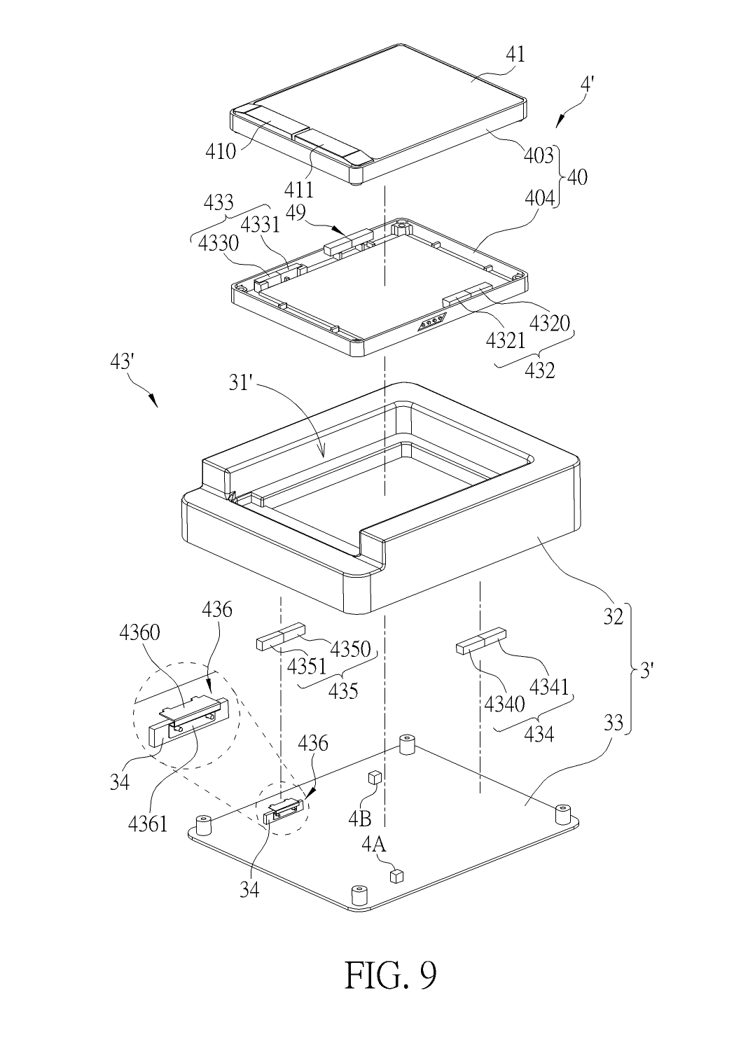

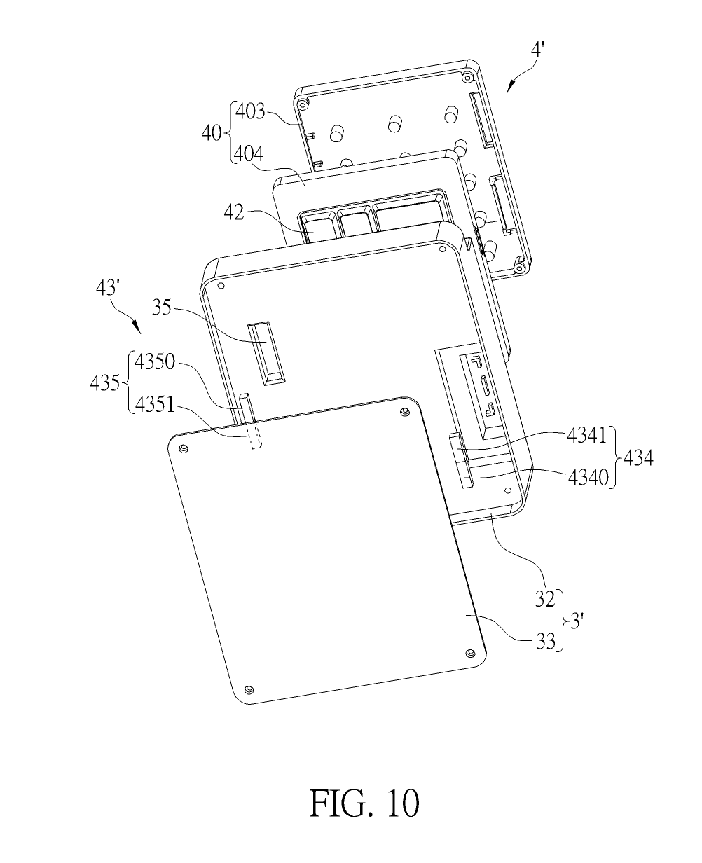

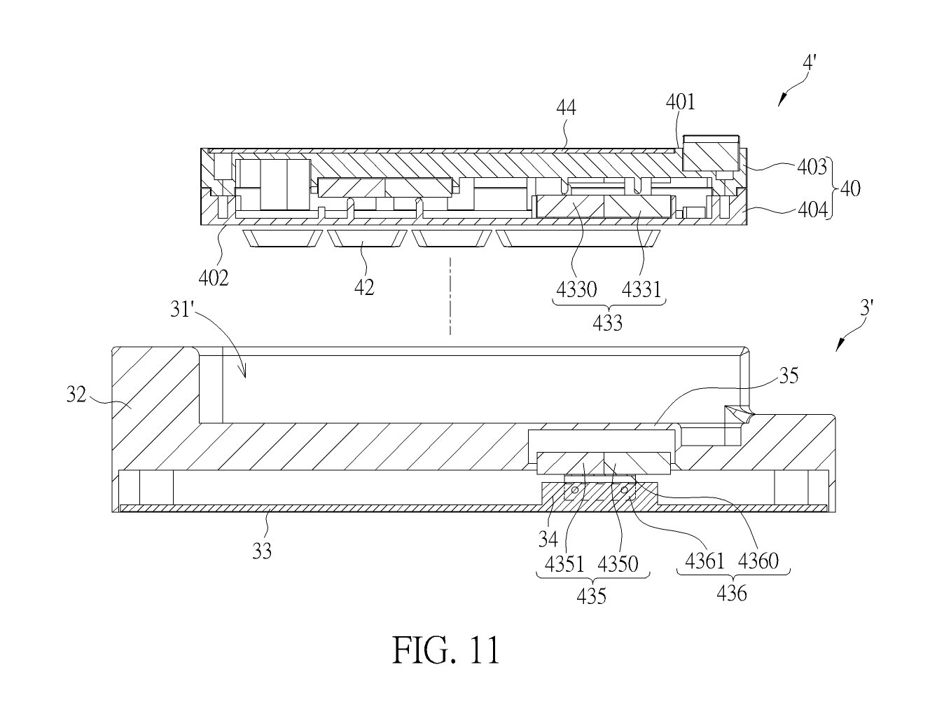

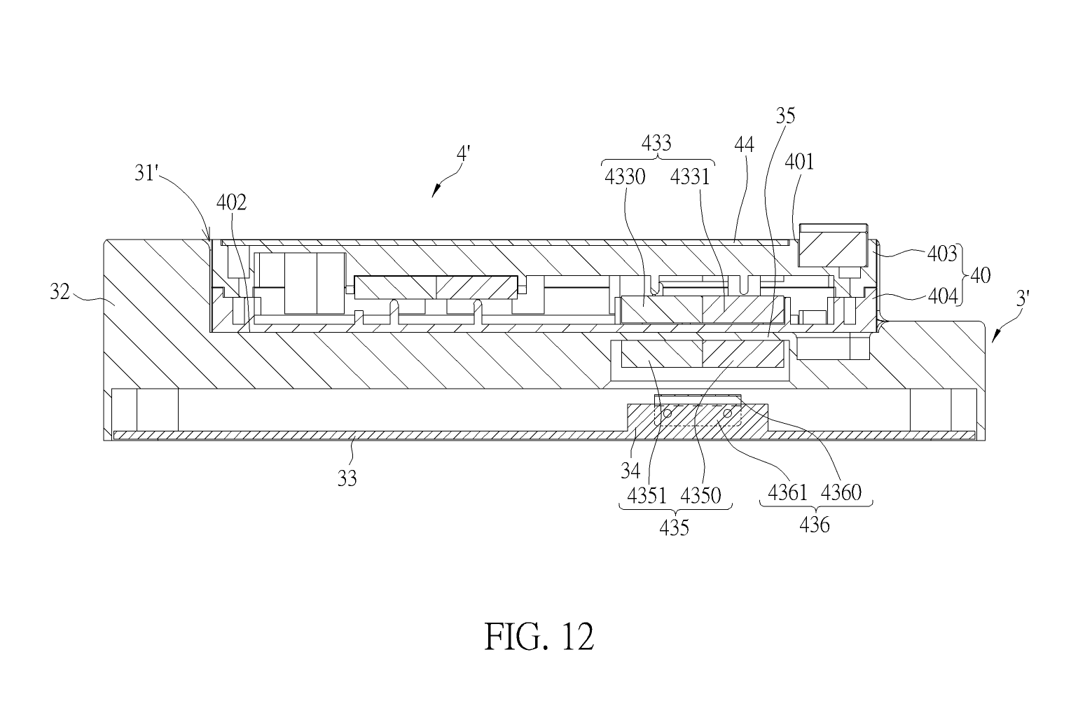

FIG. 9 is an exploded diagram of the input device 4′ according to the second embodiment of the present invention. FIG. 10 is an exploded diagram of the input device 4′ in another view according to the second embodiment of the present invention. FIG. 11 is a sectional diagram illustrating that the input device 4 is separate from the housing 3′ according to the second embodiment of the present invention. FIG. 12 is a sectional diagram illustrating that the input device 4 is combined with the housing 3′ according to the second embodiment of the present invention. As shown in FIG. 9 to FIG. 12, the housing 3′ can includes an upper housing 32 and a lower housing 33. The lower housing 33 is installed on the lower housing 32, so as to form the housing 3′ and protect internal components inside the housing 3′. Furthermore, the housing 3′ has a fixing structure 34 and a stopping structure 35. The fourth magnetic module 435 is movably disposed between the fixing structure 34 and the stopping structure 35 of the housing 3′.

When the input device 4′ is installed from a position shown in FIG. 11 to a position shown in FIG. 12 with the second face 402 of the casing 40 being oriented toward the secondary input area 31′ of the housing 3′, the fourth magnetic module 435 attracts the first magnetic module 432. However, the first magnetic module 432 is fixed on the lower casing 404 of the casing 40, the fourth magnetic module 435 is attracted toward the stopping structure 35 when the fourth magnetic module 435 and the first magnetic module 432 are attracted to each other, and the fourth magnetic module 435 is further stopped by the stopping structure 35. Meanwhile, it generates a hitting sound due to collision of the fourth magnetic module 435 and the stopping structure 35, so as to enable the user to know the input device 4′ has been completely installed in the secondary input area 31′. Similarly, when the input device 4′ is installed in the secondary input area 31′ with the first face 401 of the casing 40 being oriented toward the secondary input area 31′ of the housing 3′, the fourth magnetic module 435 is attracted by the second magnetic module 433 and moves toward and is stopped by the stopping structure 35.

In addition, the fixing mechanism 43′ of the input device 4′ further includes a magnetically attracting member 436. The magnetically attracting member 436 has an abutting portion 4360 and a fixing portion 4361. The fixing portion 4361 is combined with the fixing structure 34, so that the magnetically attracting member 436 is fixed on the fixing structure 34 of the housing 3′. When the input device 4′ is detached from the secondary input area 31′, the fourth magnetic module 435 is not attracted by the first magnetic module 432 or the second magnetic module 43. Meanwhile, the magnetically attracting member 436 attracts the fourth magnetic module 435, so as to move the fourth magnetic module 435 toward the magnetically attracting member 436. The fourth magnetic module 435 is stopped by the abutting portion 4360, so as to recover the fourth magnetic module 435.

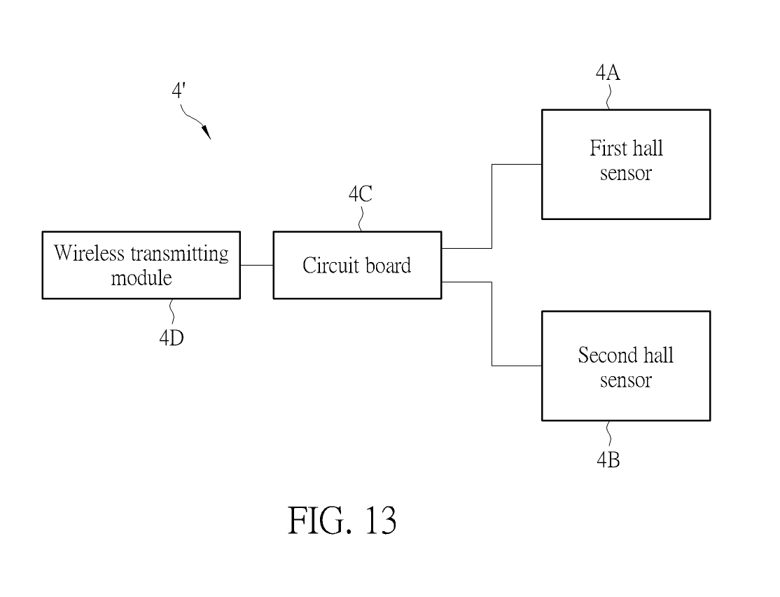

FIG. 13 is a functional block diagram of the input device 4′ according to the second embodiment of the present invention. As shown in FIG. 7 to FIG. 9 and FIG. 13, the input device 4′ further includes a magnet member 49, a first hall sensor 4A, a second hall sensor 4B and a circuit board 4C. The magnet member 49 is disposed inside the casing 40 of the input device 4′. The first hall sensor 4A and the second hall sensor 4B are disposed in the housing 3′. The circuit board 4C is disposed inside the casing 40 and electrically connected to the first input module 41, the second input module 42, the first hall sensor 4A and the second hall sensor 4B.

When the input device 4′ is installed in the secondary input area 31′ with the first face 401 of the casing 40 being oriented toward the secondary input area 31′ of the housing 3′, the magnet member 49 is corresponding to the first hall sensor 4A, so that the first hall sensor 4A is able to sense the magnetic force generated by the magnet member 49, so as to activate the second input module 42 which is exposed from secondary input area 31′. Accordingly, the user is able to operate the second input module 42. Similarly, when the input device 4′ is installed in the secondary input area 31′ with the second face 402 of the casing 40 being oriented toward the secondary input area 31′ of the housing 3′, the magnet member 49 is corresponding to the second hall sensor 4B, so that the second hall sensor 4B is able to sense the magnetic force generated by the magnet member 49, so as to activate the first input module 41 which is exposed from the secondary input area 31′. Accordingly, the user is able to operate the first input module 41.

Furthermore, the input device 4′ can further include a wireless transmitting module 4D. When the first hall sensor 4A senses the magnetic force generated by the magnet member 49 or when the second hall sensor 4B senses the magnetic force generated by the magnet member 49, the circuit board 4C activates the wireless transmitting module 4D, so that the wireless transmitting module 4D communicates with the electronic device. In this embodiment, the input device 4′ is coupled to the electronic device in a wireless manner during assembly in the secondary input area 31′, but the present invention is not limited thereto.

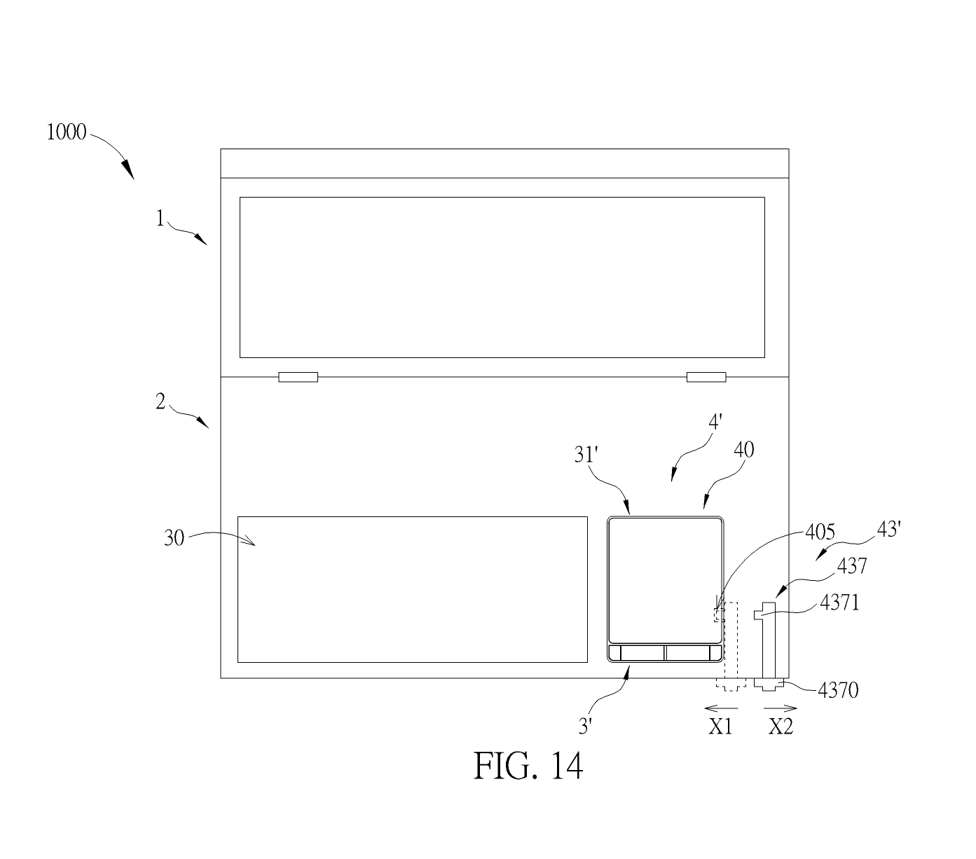

FIG. 14 is a diagram illustrating that the input device 4′ is installed in the secondary input area 31′ of the electronic device 1000 according to the second embodiment of the present invention. As shown in FIG. 14, an engaging slot 405 is formed on the casing 40 of the input device 4′, and the fixing mechanism 43′ further includes a push button 437. The push button 437 includes a button body 4370 and an engaging portion 4371. The button body 4370 is slidably disposed on the housing 3′ of the host module 2 of the electronic device 1000, and the engaging portion 4371 protrudes from the button body 4370. In this embodiment, the engaging portion 4371 is a hook structure, but the present invention is not limited thereto. Furthermore, the button body 4370 is exposed from the housing 3′. Accordingly, the user utilizes the button body 4370 for driving the engaging portion 4371 to move along an engaging direction X1. When the engaging portion 4371 is moved to a position illustrated in dotted line in FIG. 14 along the engaging direction, the engaging portion 4371 engages with the engaging slot 405 of the casing 40 of the input device 4′, so that the casing 40 of the input device 4′ is fixed on the secondary input area 31′ of the housing 3′. When the user utilizes the button body 4370 for driving the engaging portion 4371 to move from the position illustrated in dotted lines to a position illustrated in solid lines in FIG. 14 along a separating direction X2 opposite to the engaging direction X1, the engaging portion 4371 is separate from the engaging slot 405 of the casing 40 of the input device 4′. Accordingly, the casing 40 of the input device 4′ is detached from the secondary input area 31′ of the housing 3′.

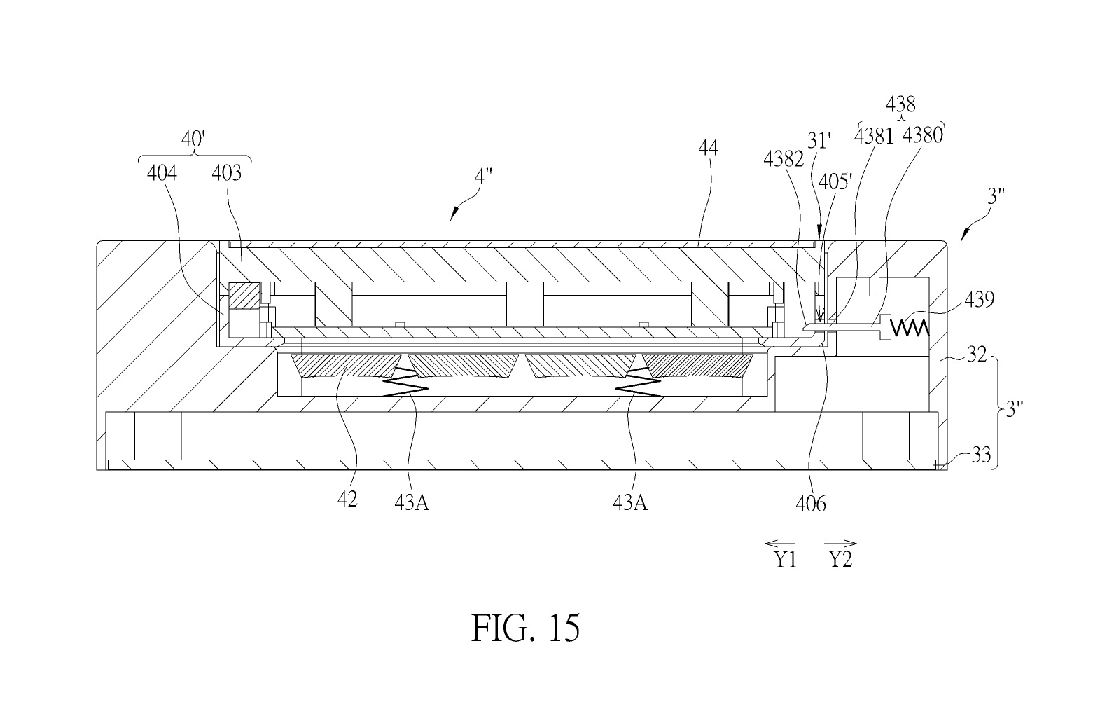

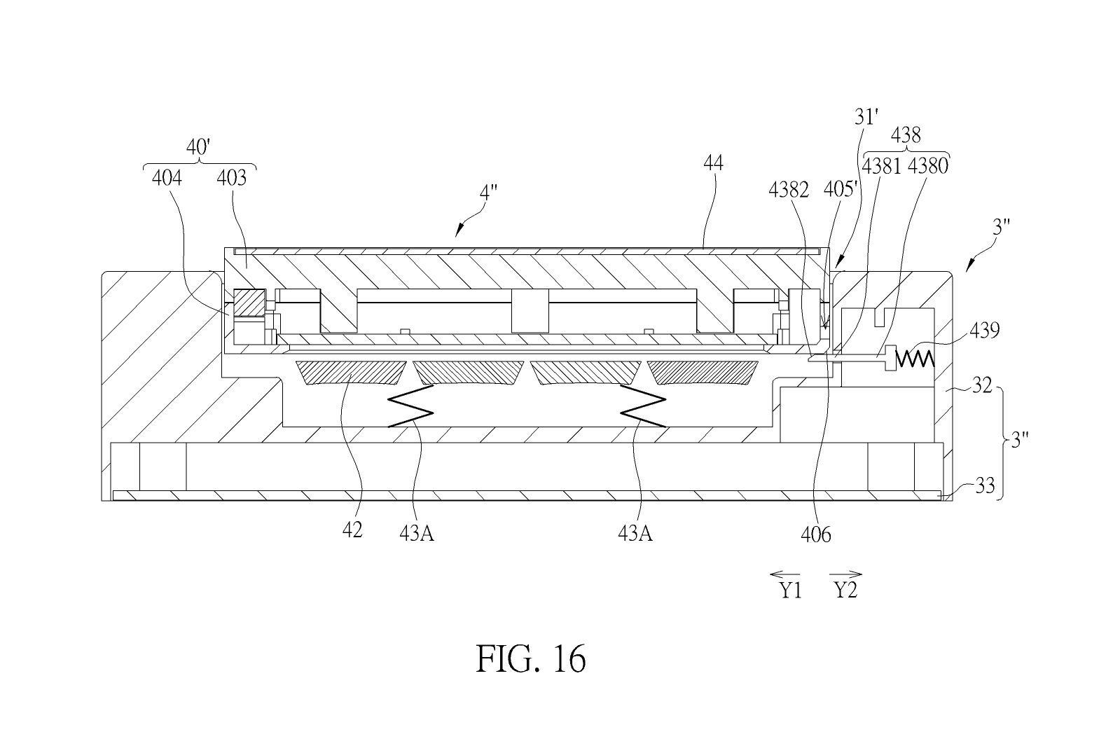

FIG. 15 is a sectional diagram illustrating that an input device 4″ is installed with a housing 3″ according to a third embodiment of the present invention. FIG. 16 is a sectional diagram illustrating that the input device 4″ is detached from the housing 3″ according to the third embodiment of the present invention. As shown in FIG. 15 and FIG. 16, the main difference between the input device 4″ and the aforesaid the input device 4′ is that a fixing mechanism 43″ of the input device 4′ includes an engaging member 438 and an elastic member 439. The engaging member 438 is installed in the housing 3″ in a slidable manner, and the elastic member 439 is disposed in the housing 3″. Furthermore, an engaging slot 405′ is formed on a casing 40′ of the input device 4″. The engaging member 438 includes a main body 4380 and an embedding portion 4381. The embedding portion 4381 extends from the main body 4380 and stretches into the secondary input area 31′. The main body 4380 is movably disposed in the housing 3′ and abuts against an end of the elastic member 439. In such a manner, when the input device 4″ is installed to an installation position shown in FIG. 15, the elastic member 439 drives the engaging member 438 to move along an embedding direction Y1 shown in FIG. 15, so that the embedding portion 4381 embeds with the engaging slot 405′ on the casing 40′. Accordingly, the engaging member 438 is able to engage and fix the casing 40′ of the input device 4″.

In this embodiment, a first guiding structure 406 can be formed on the casing 40′, and a second guiding structure 4382 can be formed on the embedding portion 4381. During the input device 4″ is installed to the installation position shown in FIG. 15, the first guiding structure 406 cooperates with the second guiding structure 4382, so that the embedding portion 4381 moves along a release direction Y2 opposite to the embedding direction Y1. Accordingly, the casing 40′ is able to achieve the installation position smoothly, so that the embedding portion 4381 is able to smoothly engage with the engaging slot 405′.

Furthermore, the fixing mechanism 43″ further includes two recovery members 43A. The two recovery members 43A are respectively installed in the secondary input area 31′. When the engaging member 438 is moved to the position where the embedding portion 4381 is separate from the engaging slot 405′ on the casing 40′ along the release direction Y2, the two recovery members 43A drive the casing 40′ of the input device 4″ to recover to a position shown in FIG. 16. An amount of the recovery member 43A is not limited to those illustrated in figures in this embodiment. The fixing mechanism 43″ can include only one the recovery member 43A, i.e., structures that the fixing mechanism 43″ includes at least one recovery members 43A are within the scope of the present invention.

Compared to the prior art, when a user is desired to use the second input module (e.g., a keyboard module) of the input device, the casing of the input device is installed on the secondary input area with the first face being oriented toward the secondary input area of the housing of a host module. Accordingly, the first input module is contained in the in the housing, and the second input module is exposed from the secondary input area, so that the user is able to operate the second input module. When the user is desired to use the first input module (e.g., a touch control module) of the input device, the casing of the input device is installed on the secondary input area with the second face being oriented toward the secondary input area of the housing of the host module. Accordingly, the second input module is contained in the in the housing, and the first input module is exposed from the secondary input area, so that the user is able to operate the first input module. In such a manner, the present invention is able to provide different operating modes of the first input module and the second input module according to user's demands on the secondary input area of the housing of the host module of the electronic device (e.g., a gaming notebook).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An input device adapted to an electronic device, the electronic device having a housing, the housing having a major input area and a secondary input area, the input device being installed on the secondary input area and comprising:
a casing having a first face and a second face opposite to the first face;
a first input module disposed on the first face;
a second input module disposed on the second face; and
a fixing mechanism disposed on at least one of the casing and the housing, the fixing mechanism fixing the casing when the casing is installed in the secondary input area with the first face being oriented toward the secondary input area, such that the first input module is contained in the housing and the second input module is exposed from the secondary input area, the fixing mechanism fixing the casing when the casing is installed in the secondary input area with the second face being oriented toward the secondary input area, such that the second input module is contained in the housing and the first input module is exposed from the secondary input area.

2. The input device of claim 1, further comprising:
a circuit board disposed inside the casing;
a first connector disposed on the circuit board and coupled to the first input module;
a second connector disposed on the circuit board and coupled to the second input module;
a third connector disposed on the casing and detachably mating with a host module of the electronic device; and
a fourth connector disposed on the circuit board and coupled to the third connector.

3. The input device of claim 2, wherein the third connector is a pogo pin connector, and the pogo pin connector comprises:
a sleeve fixed on the casing;
a pin slidably disposed in the sleeve; and
a resilient member disposed in the sleeve and abutting against the pin.

4. The input device of claim 1, wherein the first input module is a touch control module, and the second input module is a keyboard module.

5. The input device of claim 1, wherein the fixing module comprises:
a first magnetic module disposed inside the casing;
a second magnetic module disposed inside the casing; and
a third magnetic module disposed in the housing and selectively attracting the first magnetic module or the second magnetic module.

6. The input device of claim 5, wherein the fixing module further comprises:
a fourth magnetic module movably disposed between a fixing structure and a stopping structure of the housing, the fourth magnetic module selectively attracting the first magnetic module or the second magnetic module, the fourth magnetic module moving toward the stopping structure and being stopped by the stopping structure when the fourth magnetic module selectively attracting the first magnetic module or the second magnetic module; and
a magnetically attracting member fixed on the fixing structure of the housing and for attracting the fourth magnetic module.

7. The input device of claim 1, further comprising:
a magnet member disposed inside the casing; and
a first hall sensor disposed in the housing, the first hall sensor sensing magnetic force generated by the magnet member when the casing is installed in the secondary input area with the first face being oriented toward the secondary input area, so as to activate the second input module.

8. The input device of claim 7, further comprising:
a second hall sensor disposed in the housing, the second hall sensor sensing the magnetic force generated by the magnet member when the casing is installed in the secondary input area with the second face being oriented toward the secondary input area, so as to activate the first input module.

9. The input device of claim 8, further comprising:
a circuit board disposed inside the casing and electrically connected to the first input module, the second input module, the first hall sensor and the second hall sensor; and
a wireless transmitting module coupled to the circuit board, the circuit board activating the wireless transmitting module to make communication between the wireless transmitting module and the electronic device when the first hall sensor senses the magnetic force generated by the magnet member or when the second hall sensor senses the magnetic force generated by the magnet member.

10. The input device of claim 1, wherein an engaging slot is formed on the casing, and the fixing mechanism comprises:
a push button comprising a button body and an engaging portion, the button body being slidably disposed on the housing and exposed from the housing, the engaging portion protruding from the button body and detachably engaging with the engaging slot.

11. The input device of claim 1, wherein the fixing mechanism comprises:
an engaging member installed in the housing in a slidable manner and detachably engaged with the casing; and
an elastic member disposed in the housing and for driving the engaging member to engage with the casing.

12. The input device of claim 11, wherein an engaging slot is formed on the casing, and the engaging member comprises:
a main body movably disposed in the housing and abutting against an end of the elastic member; and
an embedding portion extending from the main body and stretching into the secondary input area, the embedding portion detachably embedding with the engaging slot.

13. The input device of claim 11, wherein the fixing mechanism further comprises:
at least one recovery member installed in the secondary input area and for driving the casing to recover.
